(19) United States
(12) Patent Application Publication
(10) Pub. No.: US 2006/0273719 A1
(43) Pub. Date: Dec. 7, 2006

(54) Plasma display panel

(76) Inventor: Masaki Nishimura, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/566,161

(22) PCT Filed: May 2, 2005
(86) PCT No.: PCT/JP05/08648

§ 371 Date: Jan. 27, 2006

(30) Foreign Application Priority Data
May 10, 2004 (JP) 2004-139594

(51) Int. Cl. H01J 61/00

(52) U.S. Cl. 313/567

(57) ABSTRACT

The plasma display panel disclosed can perform a high brightness displaying and can realize a stable driving on a low drive voltage. The plasma display panel has front substrate (1) and rear substrate (2) positioned facing each other to form discharge spaces in between filled with discharge gas (14), wherein the discharge gas includes at least one of chosen from among helium (He), neon (Ne) and argon (Ar); xenon (Xe) and hydrogen (H₂), in which Xe concentration is not lower than 5%.

### TECHNICAL FIELD

The present invention relates to a plasma display panel for use in a display device or the like.

### BACKGROUND ART

The plasma display panel (hereafter referred to as PDP) consists basically of a front substrate and a rear substrate.

The front substrate comprises: a glass substrate; display electrodes including stripe-like transparent electrodes and bus electrodes formed on a principal surface of the glass substrate; a dielectric glass layer covering the display electrodes to act as a capacitor; and a protective layer composed of MgO formed on the dielectric glass layer.

The glass substrate adopts a glass substrate produced by float process, a glass manufacturing technology easy for large-sizing and excellent in flattening. The display electrodes include transparent electrodes provided by the TFT (thin film transistor) processing, on which predetermined patterns are formed using a paste including Ag to obtain a sufficient electrical conductivity before sintering it to form the bus electrodes. The dielectric glass layer is formed by sintering a dielectric paste coated so as to cover the display electrodes having the transparent electrodes and bus electrodes. Finally, a protective layer composed of MgO is formed on the dielectric layer by the TFT processing.

The rear substrate comprises: a glass substrate; stripe-like address ATTACHMENT B electrodes formed on a principal surface of the glass substrate; a dielectric layer covering the address electrodes; ribs formed on the dielectric layer; and phosphor layers provided between the ribs internally to emit red, green and blue light respectively.

The front substrate and rear substrate are sealed hermetically so that principal surface sides provided with the electrodes face each other, and the discharge spaces divided by the ribs are filled with discharge gas such as Ne—Xe gas mixture at a pressure of ranging from 400 Torr to 600 Torr.

The PDP allows the display electrodes to discharge by applying image signal voltage selectively, exciting each phosphor layer to emit red, green and blue light by the ultra-violet ray generated in the discharge to perform colored image displaying. The examples are disclosed in “General Information on Plasma Display” by H. Uchiike & S. Mikoshiba, (Tokyo: Kogyo Chosakai Publishing Co., Ltd. May 1, 1997), p. 79 to 80.

In recent years, however, expectations for TV set with high-resolution and multi-gradation and that consuming less power, including high-definition TV, is increasing rapidly. Fully equipped 42-inch high-definition TV set expected recently has 1920×1125 pixels with a very small cell pitch of 0.15×0.48 mm. The problem of decrease in the brightness and luminous efficiency would become apparently in such a high-resolution PDP.

Measures therefore such as to increase Xe concentration in the discharge gas or to use double-cross shaped ribs for the PDP has been tried. However, increased Xe concentration in the discharge gas or introduction of the double-cross shaped ribs for the PDP could cause a large increase in a drive voltage and an unstable address discharge, thereby causing a problem of obtaining a high picture quality.

The present invention aims at providing a PDP capable of displaying with high brightness and of realizing a stable driving on the low drive voltage.

### DISCLOSURE OF THE INVENTION

To accomplish the above purposes the PDP of the present invention has discharge spaces filled with the discharge gas between two substrates positioned facing each other with a gap, wherein the discharge gas is composed of at least one chosen from among helium (He), neon (Ne) and argon (Ar), xenon (Xe) and hydrogen (H₂), in which Xe concentration is not lower than 5%.

The configuration, the discharge gas including Xe of the concentration of not lower than 5% added with H₂ content, can provide the PDP capable of displaying with high brightness and of realizing a stable driving in the low drive voltage.

### BRIEF DESCRIPTION OF THE DRAWINGS

FIG. 1 illustrates a cross-sectional perspective view showing the main structure of the PDP used in the exemplary embodiment of the present invention.

FIG. 2 illustrates a cross-sectional view taken along the line A-A in FIG. 1.

FIG. 3 illustrates the relationship between H₂ concentration in the discharge gas and the discharge voltage of the PDP used in the exemplary embodiment of the present invention.

FIG. 4 illustrates the relationship between Xe concentration in the discharge gas and the maximum discharge voltage drop for the PDP.

FIG. 5 illustrates a view showing brightness variations on H₂ concentration in the discharge gas for the PDP.

FIG. 6 illustrates the relationship between Xe concentration in the discharge gas and the maximum increase rate of brightness for the PDP.

FIG. 7 illustrates the relationship between Xe concentration in the discharge gas and the maximum increase rate of luminous efficiency for the PDP.

### DETAILED DESCRIPTIONS OF THE INVENTION

Now, the PDP used in the exemplary embodiment of the present invention is described with reference to drawings.

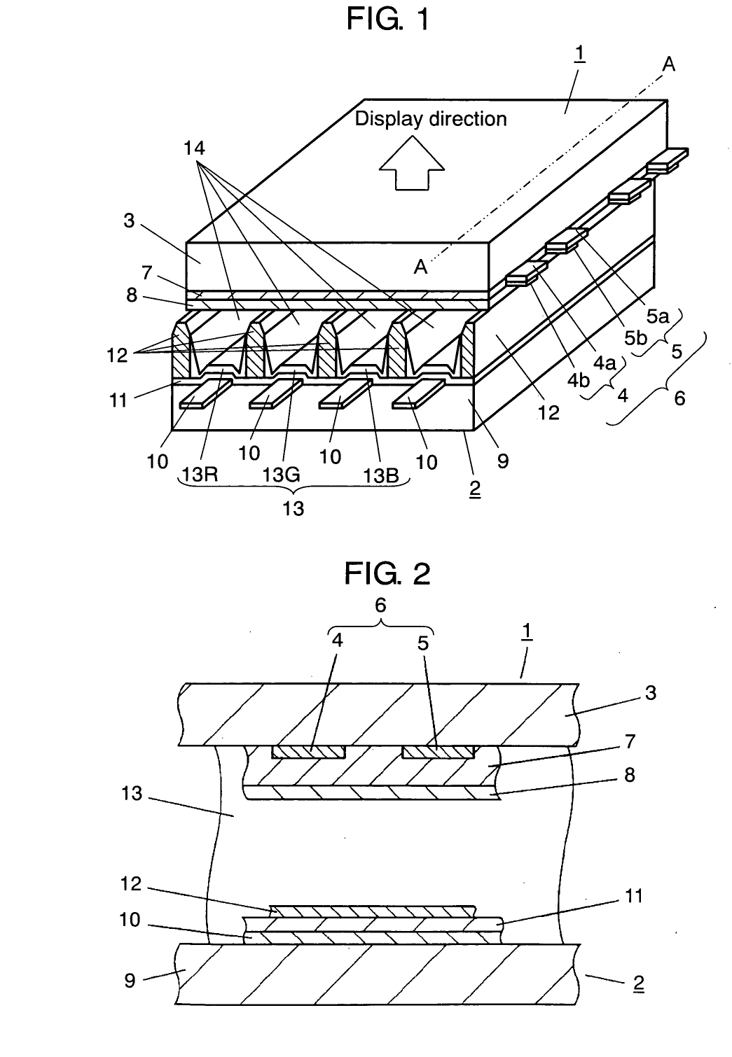

FIG. 1 illustrates a cross-sectional perspective view showing the main portion of the PDP used in the exemplary embodiment of the present invention. FIG. 2 illustrates a cross-sectional view taken along the line A-A in FIG. 1. The PDP comprises front substrate 1 and rear substrate 2 positioned facing each other so that discharge spaces are formed as shown in FIG. 1.

Front substrate 1 is described first.

Front glass substrate 3 has display electrodes 6 including stripe-like scan electrodes 4 and sustain electrodes 5 arranged on a surface facing rear substrate 2 so as to form surface discharge gaps sandwiched between the both electrodes. That is, display electrode 6 comprises a pair of scan electrode 4 and sustain electrode 5 arranged in parallel. Scan electrode 4 and sustain electrode 5 comprise: transparent electrodes 4a and 5a composed of transparent electrical conductive materials such as indium tin oxide (ITO) or tin dioxide (SnO₂); and bus electrodes 4b and 5b, having a narrower width and a higher electrical conductivity than transparent electrodes 4a and 5a, formed on transparent electrodes 4a and 5a. Bus electrodes 4b and 5b are formed of for instance Ag thick film (thickness: 2 to 10 μm), Al thin film (thickness: 0.1 to 1 μm) or Cr/Cu/Cr multi-layered thin film (thickness: 0.1 to 1 μm).

Dielectric layer 7 composed of dielectric glass materials having a glass composition of for instance PbO—SiO₂—B₂O₃—ZnO—BaO series is formed on front glass substrate 3 provided with display electrodes 6 so as to cover display electrodes 6, and protective layer 8 is formed multi-layered on the entire surface of dielectric layer 7. MgO-based thin film thus formed is to act as protective layer 8.

Rear substrate 2 is described next.

Rear glass substrate 9 has a plurality of address electrodes 10 formed arranged in stripe-shape on the surface facing front substrate 1. Dielectric layer 11 is formed additionally so as to cover address electrodes 10. Stripe-like ribs 12 for instance are disposed on dielectric layer 11 so as to be arranged between address electrodes 10. Stripe-like grooves surrounded by ribs 12 and dielectric layer 11 are provided with phosphor layers 13: red phosphor layers 13R to emit red light, green phosphor layers 13G to emit green light and blue phosphor layers 13B to emit blue light.

Front substrate 1 and rear substrate 2 thus formed are positioned facing each other so that display electrodes 6 cross address electrodes 10 to form discharge spaces 14 surrounded by stripe-like grooves formed by ribs 12 and respective color phosphor layers 13R, 13G or 13B, and protective layer 8. Front substrate 1 and rear substrate 2 are hermetically sealed in the outer periphery using sealing glasses, and subsequently discharge spaces 14 are filled with discharge gas to complete the PDP. Therefore, areas where display electrodes 6 cross address electrodes 10 work as discharge cells to perform image displaying. Discharge spaces 14 are filled with the discharge gas at a pressure of the order of 400 Torr to 600 Torr.

The PDP generates ultra-violet ray with short wave length (wave length: approximately 147 nm) in a gas discharge occurred in the discharge cells, and excites respective color phosphor layers 13R, 13G and 13B by the ultra-violet ray to perform image displaying.

In the exemplary embodiment of the present invention, discharge spaces 14 are filled with the discharge gas composed of at least one chosen from among helium (He), neon (Ne) and argon (Ar); xenon (Xe) and hydrogen (H₂), in which Xe concentration is not lower than 5%. Increased Xe concentration in the discharge gas enables the PDP to realize a displaying with high-brightness. However, a higher Xe concentration increases the discharge voltage, causing circuit parts and PDP structure to need measures to withstand a higher voltage, thereby causing increase in power consumption and parts cost eventually.

The PDP used in the exemplary embodiment of the present invention employs the discharge gas with an increased Xe concentration and with additional H₂ content, enabling to prevent the discharge voltage from increasing to perform a stable operation while realizing the display with a high brightness.

Now, sample PDPs have been manufactured to check characteristics of the PDP used in the exemplary embodiment of the present invention. The test samples include Xe concentration of 5%, 15% and 30% respectively, with H₂ content varying in concentration for each Xe concentration. The sample PDPs have been finished manufactured with discharge cells 14 filled with the discharge gas, including Ne as a buffer gas, at a pressure of 66.7 kPa (500 Torr). The discharge voltage is measured in each sample subsequently.

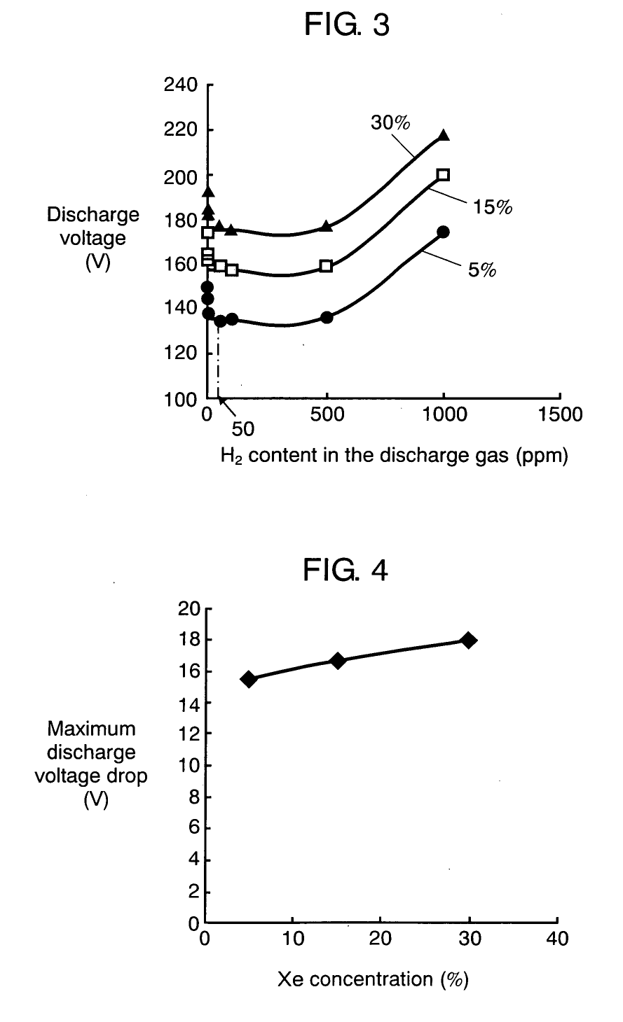

FIG. 3 shows the relationship between H₂ content in the discharge gas and the discharge voltage. The least amount of H₂ content added to the discharge gas affects a decrease in the discharge voltage in every Xe concentration as shown in FIG. 3. On the contrary, if H₂ concentration reaches of the order of a few percent, the discharge voltage proves to show an increase inversely. Namely, it proves that H₂ concentration of not higher than 0.1% or preferably not larger than 500 ppm can decrease the discharge voltage more than the case without any H₂ content.

Additionally, H₂ concentration ranging from 50 ppm to 500 ppm proves to have approximately the same effects on a decrease in the discharge voltage, showing approximately a constant value over the range. That is, if H₂ content to the discharge gas is controlled in the concentration range, it may be preferable to practical manufacturing of the PDP because the effects on decrease in the discharge voltage may be stable if the concentration of H₂ content fluctuates slightly.

FIG. 4 illustrates the relationship between Xe concentration in the discharge gas and the maximum discharge voltage drop, showing differences between the discharge voltage in the case without any H₂ content and the discharge voltage minimized by adding H₂ content in each Xe concentration.

FIG. 4 proves that H₂ content can decrease the discharge voltage in every Xe concentration, and that the maximum drop of the discharge voltage amounts to ranging approximately 15 V to 18 V. Also it proves that the higher Xe concentration, the larger the voltage lowering effect.

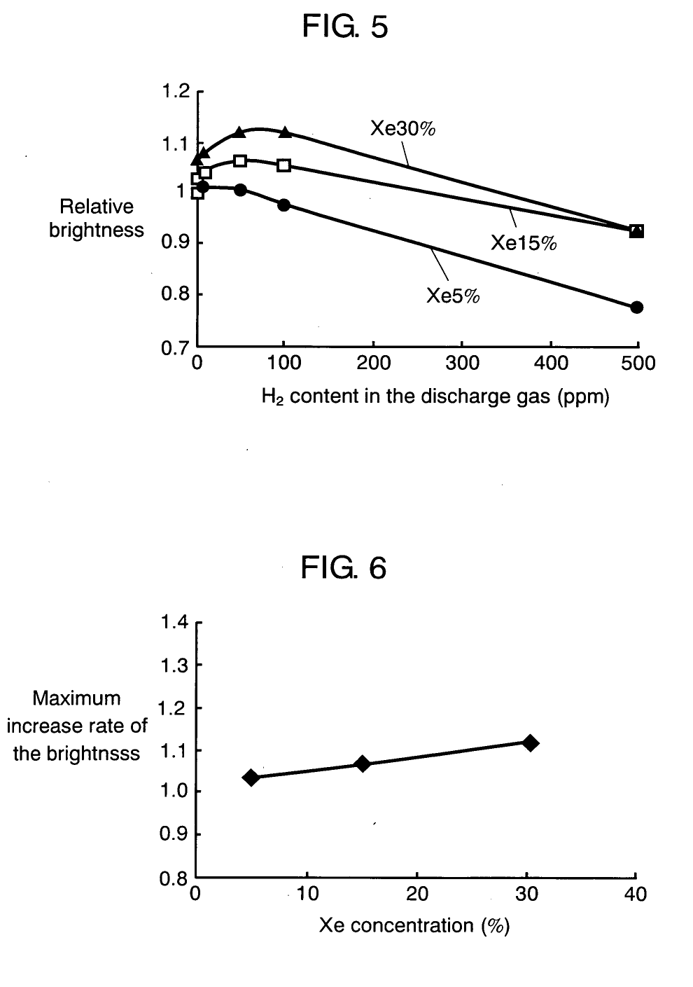

FIG. 5 illustrates a view showing variations of display brightness against H₂ concentration in the discharge gas. Relative brightness on the same discharge voltage is shown, taking the brightness in the case without any H₂ content as a normal of 1 in each Xe concentration. FIG. 5 proves that the brightness shows the maximal value with H₂ concentration of not higher than 100 ppm in every Xe concentration.

FIG. 6 illustrates the relationship between Xe concentration in the discharge gas and the maximum increase rate of the brightness. The brightness maximized by adding H₂ content in each Xe concentration is shown in increase rate, taking the brightness in the case without any H₂ content as a normal of 1. FIG. 6 proves that the higher the Xe concentration, the larger the increase rate of brightness by adding H₂ content.

The aforementioned results prove that addition of H₂ content of not higher than 100 ppm can decrease the discharge voltage and can realize the display with high-brightness.

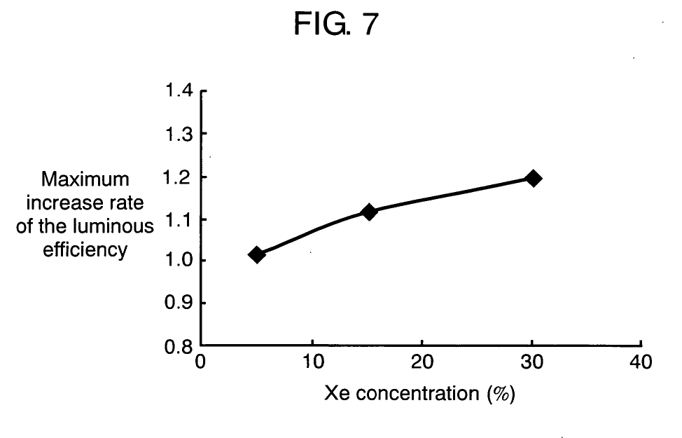

FIG. 7 illustrates the relationship between Xe concentration in the discharge gas and the maximum increase rate of the luminous efficiency. As shown in FIG. 6, though the luminous efficiency does not increase significantly in Xe concentration of 5%, but a big increase is shown with Xe concentration of not lower than 5%, and further increase with the increase in Xe concentration. Namely, it proves that an increase in the luminous efficiency can be achieved effectively by adding H₂ content with Xe concentration of not lower than 5%.

The luminous efficiency described above is determined by the following formula:
Luminous efficiency η(lm/W)=π×brightness (cd/m²)×operating area (m²)/(power for lighting−power for non-lighting)

From the above, H₂ content should be not higher than 0.1%, preferably be not higher than 500 ppm, or more preferably be not higher than 100 ppm to achieve a higher luminous efficiency when Xe concentration is not lower than 5%. That can realize approximately 20 V decrease in the discharge voltage and of the order of 20% further increase in the luminous efficiency at the same time compared with the case without any H₂ content.

The voltage lowering measures enable the PDP to decrease the discharge voltage and to reduce withstand voltage levels required for circuit parts or structure of the PDP, resulting in a cost reduction effectively.

Additionally, the voltage lowering measures also enable the PDP to operate on a lower drive voltage and to improve the luminous efficiency further if the drive voltage is optimized.

The above description results from the PDP with protective layer 8 composed of magnesium oxide (MgO) used as the main component. Considering the collision probability between the gases, the aforementioned H₂ concentration of the order of ppm is negligibly small from the collision theory, while resulting in significantly. Generally, hydrogen (H₂) decreases the electron temperature, causing the discharge voltage to increase. From the above, therefore, the results of the present invention can be considered as follows: Hydrogen (H₂) is considered to act on magnesium oxide (MgO) composing protective layer 8 forming a portion of internal surface of discharge space 14, allowing magnesium oxide (MgO) acting as a cathode to increase the electron emissivity. It is considered, therefore, that the materials of protective layer 8 should preferably include magnesium oxide (MgO) as the main component.

Although flat-reflection type PDP is used in the above description, the present invention can be adopted for facing-discharge type PDP or tube-array type PDP as well, and particularly the improvement of luminous efficiency can be a more effective measures to reduce the power consumption in large-sized PDPs such as 60-inch and upper.

### INDUSTRIAL APPLICABILITY

As aforementioned, the present invention can reduce the drive voltage of the PDP and can perform displaying with high brightness by introducing a discharge gas including Xe of the concentration of not lower than 5% added with H₂ content, which would be useful for plasma display apparatus for use in the wall-hung TV or large-sized screen monitor.

1. A plasma display panel having two substrates positioned facing each other to form discharge spaces in between filled with discharge gas, wherein the discharge gas includes at least one of chosen from among helium (He), neon (Ne) and argon (Ar), xenon (Xe) and hydrogen (H₂), in which Xe concentration is not lower than 5%.

2. The plasma display panel of claim 1, wherein hydrogen (H₂) concentration is not higher than 0.1%.

3. The plasma display panel of claim 2, wherein hydrogen (H₂) concentration ranges from not lower than 50 ppm to not higher than 500 ppm.

4. The plasma display panel of claim 1, wherein magnesium oxide (MgO) is provided at least on a portion of an internal surface of the discharge spaces.
